(19) United States
(12) Patent Application Publication
(10) Pub. No.: US 2016/0234375 A1
(43) Pub. Date: Aug. 11, 2016

(54) SAFE MESSAGING DEVICE, SYSTEM AND METHOD

(71) Applicant: Hollywood Technology LLC, Hollywood, FL (US)

(72) Inventors: Steven Jones, Dania Beach, FL (US); Paul Gaylie, British Columbia (CA)

(73) Assignee: Hollywood Technology LLC

(21) Appl. No.: 14/620,025

(22) Filed: Feb. 11, 2015

Related U.S. Application Data
(60) Provisional application No. 61/938,445, filed on Feb. 11, 2014.

(51) Int. Cl. H04M 1/725; H04W 4/04; H04L 12/801

(52) U.S. Cl. CPC H04M 1/72577; H04L 47/29; H04W 4/046

(57) ABSTRACT

A solution to mitigate personal, organizational, and network wide risks and exposure from damages and harm related to distracted driving. The invention includes a system, method, and devices that enforce a safe messaging protocol that prevents communications from being transmitted to recipients while the recipients are driving, piloting, operating heavy machinery or otherwise endangered from being distracted from incoming communications.

### CROSS-REFERENCE TO RELATED APPLICATIONS

This patent application claims the benefit under 35 U.S.C. §119(e) of U.S. Provisional Patent Application No. 61/938,445, filed Feb. 11, 2014, which application is incorporated herein by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

Distracted driving, text messaging/texting while driving and emailing while driving, or making use of personal communicators, tablets, cellphones, pagers, personal computers, radio transmitters, radio receivers, electro-magnetic transmitters, electro-magnetic receivers, and other mobile communication devices (collectively each a “Mobile Device”) threatens organizations legally, financially, and socially. It threatens the lives of organizational agents, employees, their families, and others on and along the roadway. The Occupational Health and Safety Administration (OSHA) has asked employers to prohibit texting while driving, establish procedures and rules that prohibit texting and driving at work, and incorporate safe communication. Moreover, various states have begun implementing legislation banning texting while driving and requiring the use of handsfree and BLUETOOTH while operating vehicles, which could create per se negligence and presumptions of reckless injury, putting organizations at risk for damages from tort claims and increasing insurance costs. Legal precedents already exist that create problems and legal liability for organizations regarding the distracted driving of their employees. Courts have held that an employer is liable where a sales representative or employee is driving distracted. Other Courts have held that the sender of a message is responsible for an accident when the sender could have foreseen the recipient of the message could be distracted. This has resulted in verdicts in the millions of dollars and costs organizations the distraction from business and lawyers fees of being involved in litigation. To address these existing problems associated with operating vehicles and or machinery while using mobile communications technology software developers have worked to establish systems to disable texting. Absent abstaining from sending text messages or emails, there exists no solution for message senders, message recipients and their business organizations and associations to avoid potential liability or distracted driving.

2. Description of the Related Art

Before the present invention, distracted driving was prevented through changing the state on the phone or through organizational policies that change the status of a phone from normal operating to safe driving. For example, the inventor herein created a MOBILE DEVICE TRACKING MONITORING SYSTEM AND DEVICE FOR ENFORCING ORGANIZATIONAL POLICIES AND NO DISTRACTED DRIVING PROTOCOLS described in U.S. patent application Ser. No. 13/857,130 (filed Apr. 4, 2013), which is incorporated herein by reference. This invention and others do not provide a standard protocol for safe messaging.

### SUMMARY OF INVENTION

The invention addresses these concerns, by using a novel approach directed toward safe messaging by holding messages and other communications in a buffer while the recipient is driving, piloting, cycling or operating dangerous machinery. This system creates a reasonable standard of care that protects the sender and recipient.

The invention queues messages and only delivers them when it is safe, because the recipient is no longer engaged in driving, piloting, cycling or operating dangerous machinery.

The invention also provides a mechanism for automatic feedback to the sender of the communications that the recipient is engaged in a task that requires concentration such as driving, piloting or operating heavy machinery.

### BRIEF DESCRIPTION OF THE DRAWINGS

The accompanying drawings, which are included to provide a further understanding of the invention and are incorporated in and constitute a part of this specification, illustrate embodiments of the invention and together with description serve to explain the principles of the invention.

In the drawings:

FIG. 1 is a flow chart of the safe messaging system of the instant invention.

FIG. 2 is a flow chart illustrating two examples of alternative procedures for the determination and queuing of messages of the instant invention.

FIG. 3 is a flow chart illustrating an example of the hardware components of the safe messaging system.

FIG. 4 is a table showing an example of data structures for a user status.

FIG. 5 is a table showing an example of a data structure for a message queue.

### DETAILED DESCRIPTION OF THE INVENTION

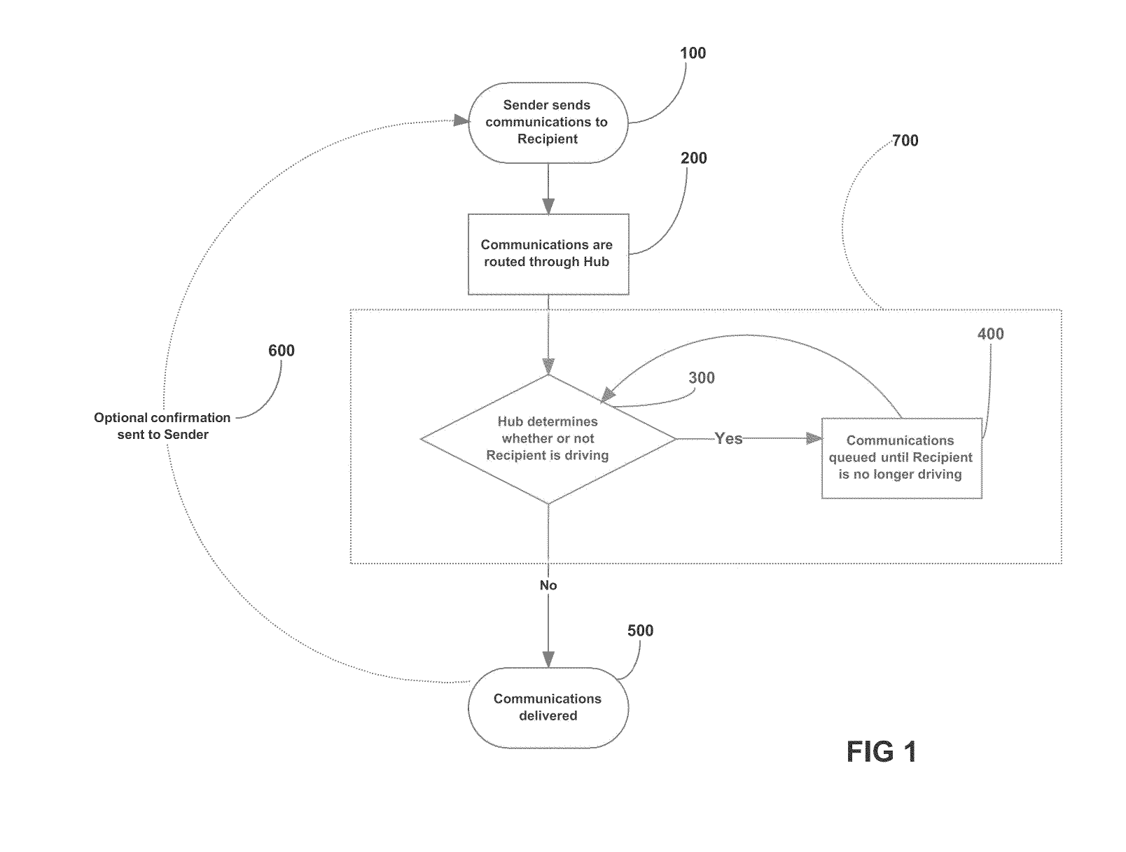

Example embodiments of the invention are described in the drawings. FIG. 1 illustrates a communication from a sender 100 being delivered to a recipient 500. The communication is routed through a hub 200. The hub determines whether or not the recipient is engaged in an activity requiring the recipient's undistracted, focused attention, such as driving, piloting or operating heavy machinery. 300. If the recipient is engaged in activity requiring the undistracted attention of the recipient the communications are queued by the hub until the recipient can safely receive the communications without being distracted. 400.

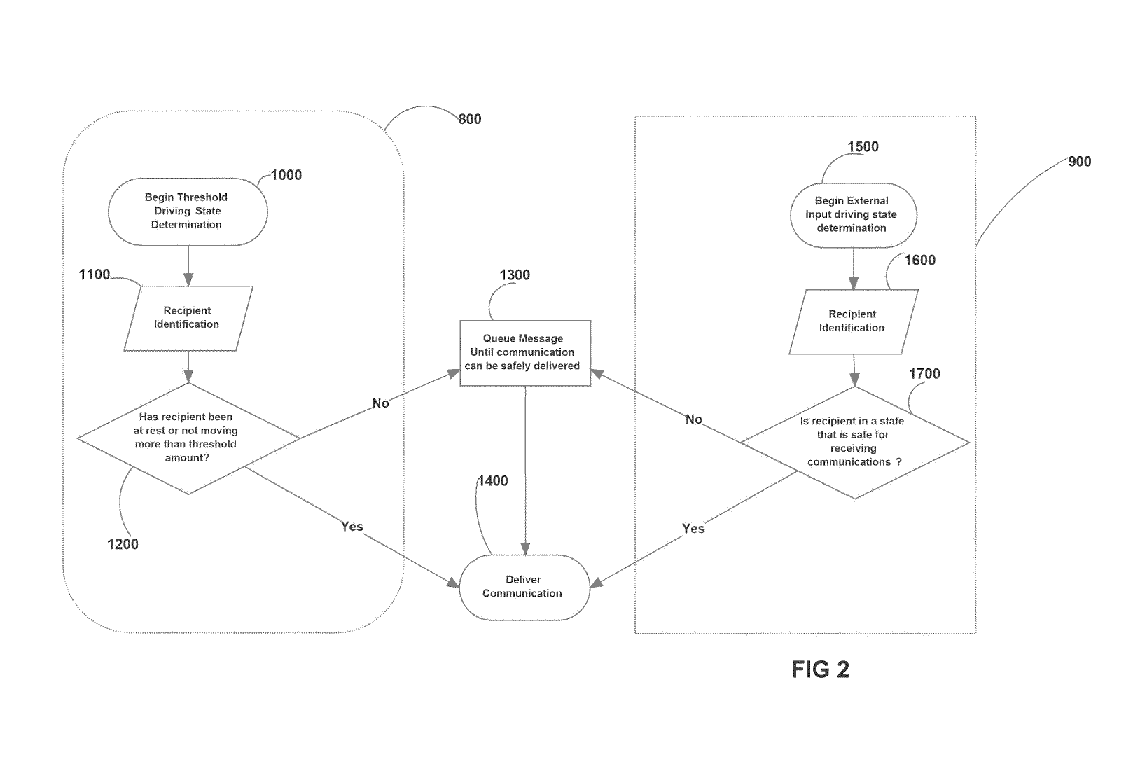

FIG. 2. shows two alternative procedures for the hub to determine whether to deliver or queue delivery of communications to a recipient. In the first example process, the hub determines a threshold driving state determination 1000 by first identifying the recipient. 1100. If the recipient has been not moving for a predefined period of time 1200 then communications are delivered, i.e., the recipient is focused and not distracted. 1400. Otherwise the communications are queued 1300 until the recipient's movement falls below the threshold value for a specific period of time. Movement is determined by accelerometer, GPS, network, or other ways known in the art to track acceleration and speed. Movement is defined as the minimum acceleration or speed for a specified period of time without rest for a specified period. The threshold value is configured through a management panel operated remotely. For example, if a mobile device exceeds more than seven (7) miles per hour for at least three (3) seconds, the recipient is considered moving. Then, after being at rest, or moving less than seven (7) miles per hour for at least thirty (30) seconds or more, the device is considered safe for delivery of the communications to Recipient. 1400. In one embodiment the mobile device reports to the hub when it is safe to receive a message. In another, embodiment the hub repeatedly checks the threshold driving state to determine if the recipient has not been moving for a predefined period of time 1200 to allow safe delivery of communications.

In an example embodiment, GPS technology, using maps or other tracking software, is used to determine if the recipient is driving on a road or using public transportation, such as, but not limited to, a bus, train, subway, ship, or aircraft. If the recipient is the driver of a vehicle that is in movement, communications are queued. However, if the recipient is using public transportation, i.e., not the driver of a vehicle, the device verifies the recipient is not driving and Communications are delivered.

Preferably, for security reasons, the device's movement is tracked at the hub through network triangulation or other off device methods. However, alternatively the hub polls a device, or a device pushes its status to the hub. The polling or pushing of the device status is initiated periodically or upon a triggered event, including but not limited to a change in the device's status or upon a communications delivery request.

In an alternative procedure, illustrated in FIG. 2, an external input is used to determine the status of the mobile device. 1500. Like in the threshold determination process of 1000, the external input process begins by identifying the recipient. 1600. Once the recipient is identified, on board diagnostics (OBD) or other sensors inform the hub if it is safe to send the recipient a message. 1400. Depending on the type of sensor used, various threshold values and tests are programmed to identify that the Recipient is available to receive messages. Some sensors interact directly with the Mobile Device, which then either pushes its status determination to the hub or makes it available for pulling upon request. In one example embodiment, the hub repeatedly checks the status of the mobile device 1500 to determine if the recipient is in a state that is safe to receive communications 1700. In other embodiments the mobile devices notifies the hub when it available to safely receive a queued message.

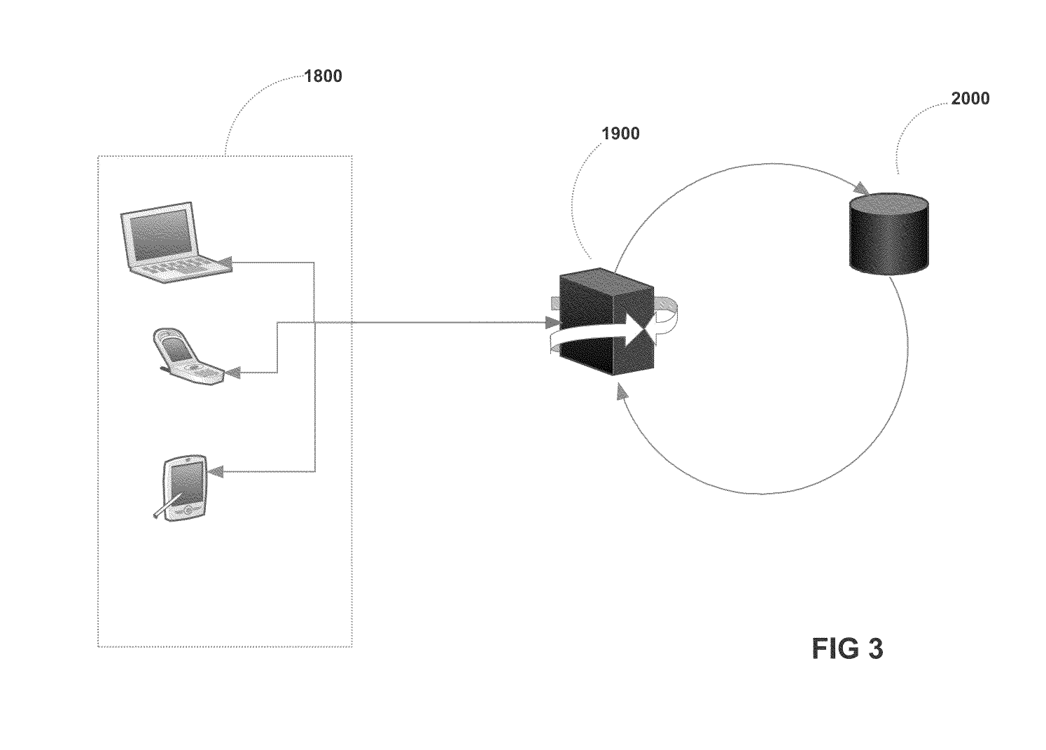

In FIG. 3, a Mobile Device is connected wirelessly to a computer network with a display screen and speaker for output. A Mobile Device 1800 also may provide USB, serial, radio and other electromagnetic input and output. Mobile Device 1800 typically has one or more GPS tracking units, accelerometers and other means such as sensors or receivers for triangulation information over a computer network for detecting movement and estimating the speed of Mobile Device 1800. Those skilled in the art appreciate other means of estimating speed and detecting movement of Mobile Device 1800.

Mobile Devices typically have default configurations executable and controllable by computer code.

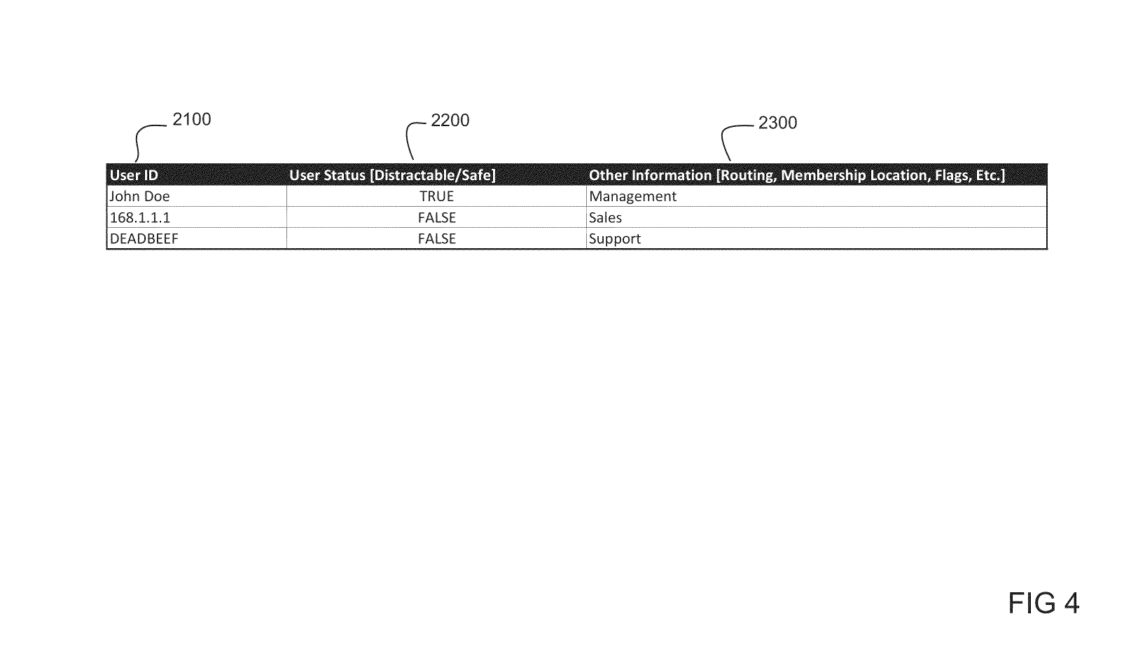

In an example embodiment, the hub 1900 communicates with a user database 2000. The user database 2000 comprises one or more tables, database servers or other data stores. It is stored at the hub, on the network or on a Mobile Device. As shown in the table in FIG. 4 the user database includes lists of user ID's 2100 and user statuses 2300.

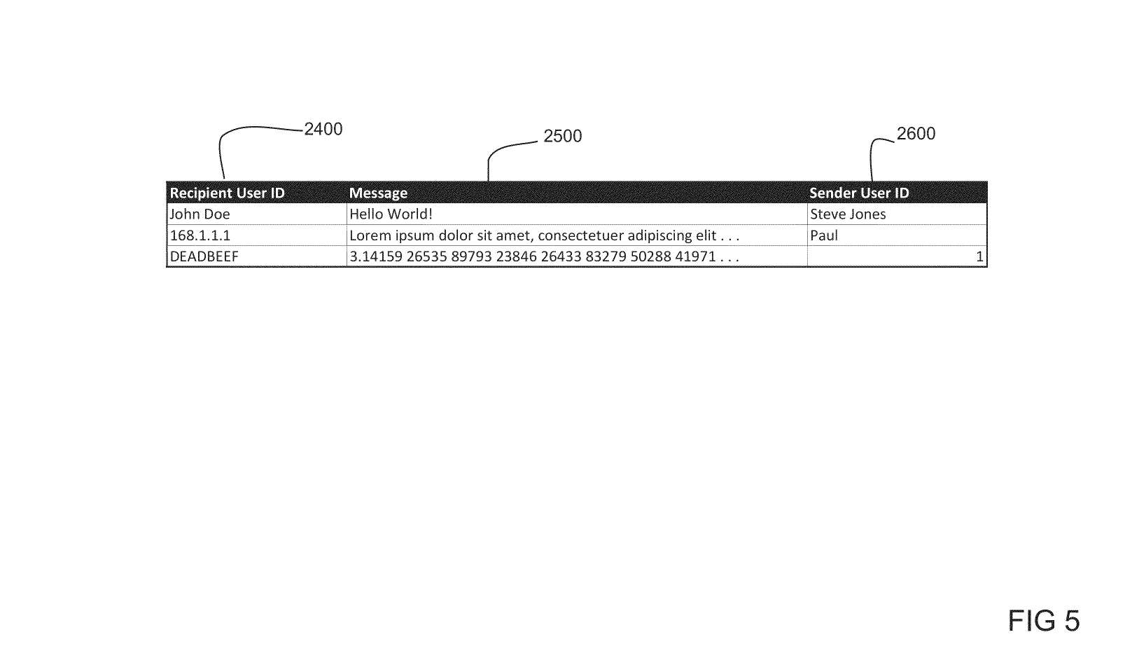

As shown in FIG. 5, The user database or another database or data store stores queued messages. The queued message data store stores information sufficient to identify the recipient 2400, the message 2500 and the sender 2600. It also includes additional information including but not limited to whether or not a message was delivered, formatting and delivery information. In some embodiments the messages are removed or deleted from the queue once they have been delivered, while in other embodiments delivered messages are marked as delivered. The marking could be a Boolean value, flag, timestamp, location, other indicator or any combination of markings.

By implementing the system of the present invention, organizations take a proactive stance to discourage and enforce policies to avoid negligent behavior by their employees and agents. By preventing the delivery of messages when a recipient is in a distractible state, the invention protects the organization, the sender, recipient and other people from the dangers of being distracted. With delivery of messages only occurring when it is safe for the recipient to receive the message, the invention insulates the organization, the sender, and the communications network from claims of negligence, which may reduce insurance costs.

Having thus described preferred embodiments, it should be apparent to those skilled in the art that certain advantages of the described system have been achieved. It should also be appreciated that various modifications, adaptions, and alternative embodiments thereof may be made within the scope and spirit of the present invention. The invention is further defined by the following claims.

What is claimed is:

1. A system for preventing distracted driving, comprising:
an electronic sender of communications;
an electronic hub for routing communications; and
an electronic recipient of communications; wherein:
said electronic hub delivers the communications when the recipient is below a threshold speed,
said electronic hub queues communications when the recipient exceeds a threshold speed.

2. A method of enforcing an organizational policy for anti-distracted driving, which comprises:
using a hub that only delivers communications to a recipient when the recipient is below a threshold speed.

3. A communications intermediary, comprising:
a user database;
a message queue;
a means to determine if the user of an electronic recipient of a communication is engaged in a distracting activity;
a means to deliver a communication only when the recipient maintains focus while receiving a communication.
